(19) United States
(12) Patent Application Publication
(10) Pub. No.: US 2025/0239174 A1
(43) Pub. Date: Jul. 24, 2025

(54) Singing Assistance Mask

(71) Applicant: Ichiro OKUYAMA, Kurume-shi Fukuoka (JP)

(72) Inventor: Ichiro OKUYAMA, Kurume-shi Fukuoka (JP)

(21) Appl. No.: 19/176,045

(22) Filed: Apr. 10, 2025

Related U.S. Application Data
(63) Continuation-in-part of application No. PCT/JP2023/031080, filed on Aug. 29, 2023.

(30) Foreign Application Priority Data
Oct. 18, 2022 (JP) 2022-166583

(51) Int. Cl. G09B 15/00; G10G 7/00; G10K 11/20

(52) U.S. Cl. CPC G09B 15/00; G10G 7/00; G10K 11/20

(57) ABSTRACT

A singing assistance mask that transmits a voice emitted from the mouth of a wearer to the ears of the wearer as sound conducted through air may comprise a front mask body that covers the mouth of the wearer; and cheek contacting regions that extend in a front-to-back/back-to-front direction so as to be directed toward locations in vicinities of the ears at left and right sides of the front mask body, and may have formed at insides thereof concavities constituting sound passages. Cheek contacting regions may comprise volume adjustment members for mechanically adjusting volume of the sound conducted through air that is transmitted to the ears. Ear proximate notched holes may be formed at back ends of cheek contacting regions. Volume adjustment members may adjust degrees to which ear proximate notched holes are made to be open.

### CROSS-REFERENCE TO RELATED APPLICATION(S), BENEFIT/PRIORITY CLAIM(S), AND INCORPORATION(S) BY REFERENCE

This application is a continuation-in-part of and claims benefit under 35 USC 120 and 365(c) to copending International Application No PCT/JP2023/031080, entitled “Singing Assistance Mask”, filed 29 Aug. 2023; and further claims benefit of priority under 35 USC 119(a)-(d) to Japanese Patent Application No 2022-166583, entitled “Singing Assistance Mask”, filed 18 Oct. 2022, the contents of all of which applications are incorporated herein in their entireties by reference.

### STATEMENT REGARDING PRIOR DISCLOSURES BY INVENTOR UNDER 37 CFR 1.77 (b)(6)

The following patents and published patent applications are disclosures by, originating with, and/or attributable to the inventor of the present application:
WO 2024 084820 A1 (“Singing Assistance Mask”; 25 Apr. 2024); and
JP 2024 059123 A (“Singing Assistance Mask”; 1 May 2024).

### FIELD OF THE INVENTION

The present invention relates to a singing assistance mask for assisting in becoming skillful at singing songs.

### BACKGROUND

A singing assistance mask or other such an acoustic accouterment in accordance with one embodiment of the present invention enables the wearer to listen objectively to his or her own voice not as sound conducted through bone but as sound conducted through air.

Because the wearer of such an acoustic accouterment is able to sing a song while objectively monitoring in real time how his or her own voice would sound to someone else, this makes it possible to improve singing ability.

As the loudness of peoples' voices and their auditory perception levels vary widely, a mask or other such acoustic accouterment that does not permit adjustment of the intensity of sound conducted through air and transmitted to the ears of the wearer may have disadvantages in that hearing-impaired persons may be unable to hear their own voices, and persons with loud voices may be unable to hear other sounds because the sounds of their own voices conducted through air are too loud, for example.

There is therefore a need to provide a singing assistance mask that makes it possible to adjust the intensity of the sound of the voice that is emitted from the mouth of the wearer and propagates to the ears as sound transmitted through air.

### SUMMARY OF INVENTION

A singing assistance mask associated with one embodiment of the present invention may transmit a voice emitted from a mouth of a wearer to ears as sound conducted through air.

Such a singing assistance mask may comprise a front mask body that covers the mouth.

Such a singing assistance mask may comprise cheek contacting regions.

The cheek contacting regions may extend in a front-to-back/back-to-front direction so as to be directed toward locations in vicinities of the ears at left and right sides of the front mask body.

The cheek contacting regions may have formed at insides thereof concavities constituting sound passages which guide the voice as the sound conducted through air to the ears of the wearer.

The cheek contacting regions may comprise volume adjustment members for mechanically adjusting volume of the sound conducted through air that is transmitted to the ears.

A singing assistance mask associated with one or more embodiments of the present invention may make it possible for the intensity of the sound of a voice that is transmitted as sound transmitted through air to the ears to be mechanically adjusted by means of volume adjustment members, and may make it possible for a wearer thereof to effectively improve his or her singing ability.

Other embodiments, systems, methods, and features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a singing assistance mask associated with a first embodiment of the present invention as seen from the exterior thereof.

FIG. 2 is a perspective view of a singing assistance mask associated with the first embodiment of the present invention as seen from the interior thereof.

FIG. 3 is a drawing to assist in describing how the singing assistance mask associated with the first embodiment of the present invention might be used.

FIG. 4 is a drawing showing how the singing assistance mask associated with the first embodiment of the present invention might be worn.

FIG. 5 is a perspective view of a singing assistance mask associated with a first variation on the first embodiment of the present invention as seen from the exterior thereof.

FIG. 6 is a perspective view of a singing assistance mask associated with a second embodiment of the present invention as seen from the exterior thereof.

FIG. 7 is a perspective view of a singing assistance mask associated with the second embodiment of the present invention as seen from the interior thereof.

FIG. 8 is a drawing to assist in describing how the singing assistance mask associated with the second embodiment of the present invention might be used.

FIG. 9 is a drawing showing how the singing assistance mask associated with the second embodiment of the present invention might be worn.

FIG. 10 is an enlarged perspective view of a singing assistance mask associated with a second variation on the second embodiment of the present invention.

FIG. 11 is a perspective view of a singing assistance mask associated with a third variation on the second embodiment of the present invention as seen from the interior thereof.

FIG. 12 is an enlarged perspective view of a singing assistance mask associated with a fourth variation on the second embodiment of the present invention.

### EMBODIMENTS FOR CARRYING OUT INVENTION

### First Embodiment

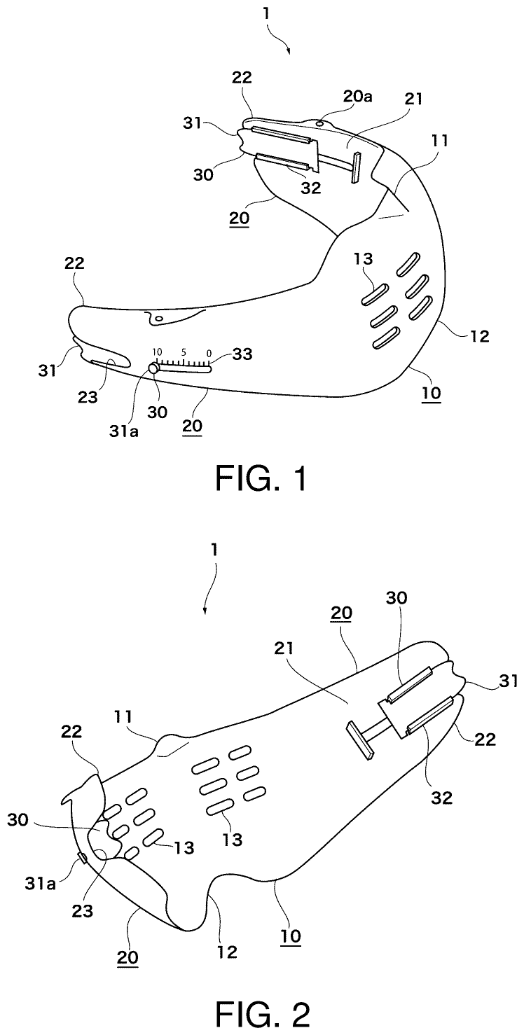

A first embodiment of the present invention will be described below with reference to FIG. 1 through FIG. 5. Singing assistance mask 1 associated with the first embodiment, which might, for example, be a mask for a person who is slightly hard of hearing, is capable of causing the voice which is emitted from the mouth of the wearer to be transmitted to the cars as a comparatively loud sound.

Singing assistance mask 1 in accordance with the present embodiment, which when used is worn on the face of a human being, comprises front mask body 10 which is positioned at the front of the face and covers the mouth; check contacting regions 20 which extend to the vicinity of the cars at both the left and right sides of front mask body 10; and fastening strap 39. Front mask body 10 and cheek contacting regions 20 might, for example, be integrally formed by resin molding.

In accordance with the present embodiment, front mask body 10, which is shaped so as to be convexly curved at the front side thereof and to generally conform to the shape of the surface of the face so as to cover the region around the mouth and nose of the wearer, comprises nose convexity 11 which is formed centrally in the lateral direction at an upper portion thereof; chin concavity 12 which is formed centrally in the lateral direction at a lower portion thereof; and a plurality of air holes 13 which are formed at locations displaced to both the left and right sides from the midpoint in the lateral direction.

In accordance with the present embodiment, nose convexity 11, which is a portion thereof that encloses the nose of the wearer, is formed such that a region in the vicinity of the center at the top end of front mask body 10 bulges out frontwardly therefrom. In accordance with the present embodiment, chin concavity 12, which is a portion thereof that is open to the chin of the wearer, is formed such that a region in the vicinity of the center at the bottom end portion of front mask body 10 is recessed upwardly therefrom. In accordance with the present embodiment, the majority of the sound of the voice emitted toward the front from the mouth of the wearer is reflected at the inner surface of singing assistance mask 1 and is guided to the cars of the wearer via sound passages 21, described below, but a portion thereof is discharged to the exterior of singing assistance mask 1 from chin concavity 12.

Thus, because in accordance with the present embodiment a portion of the sound of the voice is discharged from chin concavity 12, it is still possible for a person nearby the wearer of singing assistance mask 1 to directly hear the sound of the voice that is emitted by the wearer. That is, while allowing his or her own voice to be heard by persons nearby, the wearer of singing assistance mask 1 of the present embodiment can simultaneously monitor the sound of his or her own voice as it is conducted through air by listening to it with his or her own cars.

Because if chin concavity 12 were shaped so as to extend as far as the front central region opposite the mouth of the wearer this could cause the majority of the sound of the voice that would otherwise be transmitted from the mouth to the cars to leak to the exterior from this chin concavity 12, chin concavity 12 is in the present embodiment preferably formed at a location that does not reach the mouth of the wearer.

Furthermore, for causing a portion of the sound of the voice of the wearer to be discharged to the exterior to the front of singing assistance mask 1, not only is it possible to employ a configuration such as that of chin concavity 12, but it is also possible to cause sound-transmitting opening(s) of such size(s) as to permit passage therethrough of the sound of the voice to be formed in a region in the vicinity of the center at the bottom end portion of front mask body 10.

In such case, because if sound-transmitting opening(s) were formed in a front central region opposite the mouth of the wearer or at sound passages 21 from the mouth to the cars this could cause the majority of the sound of the voice that would otherwise be transmitted to the cars to leak to the exterior from such opening(s), it is preferred in accordance with the present embodiment that sound-transmitting opening(s) not be formed in the region opposite the mouth of the wearer or at sound passages 21 from the mouth to the cars.

In accordance with the present embodiment, air holes 13, which are holes through which air passes when the wearer breathes, are constituted from a plurality of small horizontally long holes that are formed in front mask body 10. In accordance with the present embodiment, when singing assistance mask 1 is worn, to cause the sound of the voice of the wearer to be guided to the cars, the interior portion of singing assistance mask 1 is preferably made to come in contact with the face of the wearer such that the space in the gap between the face of the wearer and singing assistance mask 1 is sealed to a certain degree.

Whereas the breathing of the wearer might be labored and there might be occurrence of unwanted sound due to friction and so forth as air is made to pass through narrow gaps when the wearer breathes if there were no openings to allow air to flow in and out between the interior space and the exterior space, air holes 13 are therefore preferably provided so as to prevent occurrence of such problematic situations.

It is preferred that a plurality of air holes 13 respectively be formed in front mask body 10 at locations to both the left and right of the center in the lateral direction, avoiding the front central region opposite the mouth of the wearer and the sound passages 21 from the mouth to the cars. Were air hole(s) 13 to be located at the front central region or the like, this could cause occurrence of a situation in which some of the sound of the voice that is emitted from the mouth leaks to the exterior from the air hole(s) 13, which could reduce the volume of the sound of the voice that is transmitted to the ears.

It is therefore preferred that air holes 13 be provided at locations other than the front central region opposite the mouth of the wearer or the sound passages 21 from the mouth to the ears. Furthermore, because if air hole(s) 13 are too large in size this could cause much of the sound of the voice to leak to the exterior by way of the air hole(s) 13, it is preferred, within ranges such as will permit the wearer to breathe without undue effort, that air holes 13 having openings that are as small as possible be provided in such number as will cause the total area thereof to be as small as possible.

In accordance with the present embodiment, cheek contacting regions 20, which are plate-like members that extend in continuous and integral fashion from locations toward the front to locations toward the rear in the vicinities of the cars at both the left and right sides of front mask body 10, transmit the sound of the voice of the wearer to the cars as sound conducted through air, and also function so as to cause singing assistance mask 1 to be held to the face as a result of contact made therewith from both sides by the cheeks or other such locations at the sides of the head of the wearer.

In accordance with the present embodiment, check contacting region 20 is curved in shape such that it protrudes outward near the center in the height direction over approximately the entire length thereof, the inside of this curve functioning as sound passage 21 to guide sound conducted through air, the sound of the voice of the wearer being made to pass through the interior of this sound passage 21 as it is directed toward the ear at the rear from the front thereof.

Length of check contacting region 20 is preferably such as will cause ear proximate region (ear covering region) 22 at the back end portion thereof to reach a location at which it will cover the ear when worn by an adult of average size, ear proximate notched hole 23, which is notched so as to be directed toward the front therefrom, preferably being formed at the back end of ear covering region 22. Note that what is referred to herein as ear proximate notched hole 23 includes not only holes formed such that the notch thereof reaches the edge at the back end of ear covering region 22 but also holes that do not extend to the edge but are formed so as to be of elongated oval or rectangular shape.

In accordance with the present embodiment, while sound transmitted by sound passage 21 at the interior of cheek contacting region 20 enters the ear which is toward the interior from ear covering region 22 at the back end thereof, a portion of the sound is preferably discharged to the exterior by way of this ear proximate notched hole 23. Moreover, whereas in accordance with the present embodiment the fact that the ear is covered by ear covering region 22 may make it difficult for the wearer to hear external sounds during wearing thereof, by increasing the size of the opening at ear proximate notched hole 23 it will be possible to cause external sounds to be easily heard by way of ear proximate notched hole 23.

In accordance with the present embodiment, check contacting region 20 further comprises volume adjustment member 30, by means of which the intensity of the sound that reaches the ear of the wearer by way of sound passage 21 may be adjusted as a result of adjustment of the degree to which ear proximate notched hole 23 is made to be open. In accordance with the present embodiment, volume adjustment member 30 comprises slide member 31; slide rail 32; and gradations 33.

In accordance with the present embodiment, slide rail 32, which extends in the front-to-back/back-to-front direction at the interior of check contacting region 20, retains plate-like slide member 31 so that it is slidable in the front-to-back/back-to-front direction relative to sound passage 21. Slide member 31 is preferably capable of slidably occluding ear proximate notched hole 23 such that it is possible to vary the area of ear proximate notched hole 23 that is occluded by slide member 31; i.e., such that it is possible to adjust the degree to which ear proximate notched hole 23 is made to be open.

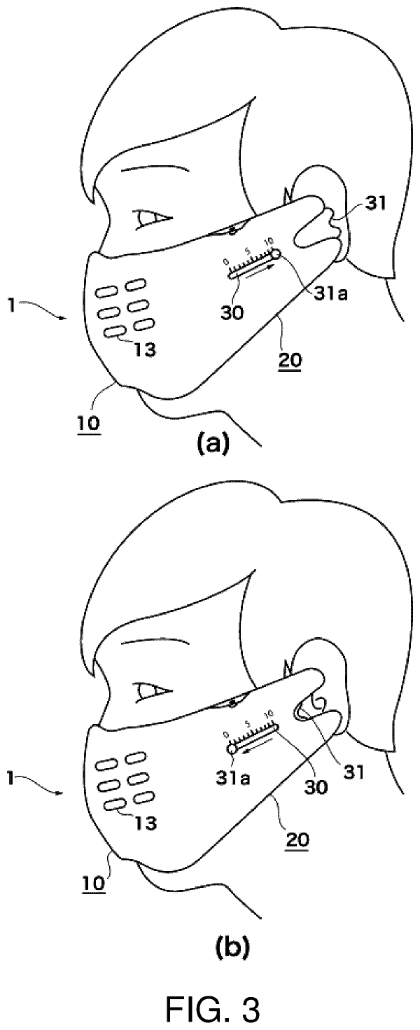

In accordance with the present embodiment, slide member 31 is slidable between a closed state (see (a) at FIG. 3) at which ear proximate notched hole 23 is completely occluded, and an open state (see (b) at FIG. 3) at which it is completely open. Gradations 33, which might, for example, be inscribed on the outside surface of check contacting region 20, may indicate the degree to which ear proximate notched hole 23 is made to be open; i.e., the volume of the sound of the voice that reaches the ear of the wearer from sound passage 21.

Formed at the outside surface of slide member 31 of the present embodiment is knob 31a which may protrude to the exterior from a hole formed in check contacting region 20, it being possible, e.g., as is the case in the present embodiment, for the wearer by using his or her finger to slide this knob 31a to easily cause slide member 31 to be made to slide in the front-to-back/back-to-front direction while singing assistance mask 1 is still worn on his or her face. That is, in accordance with the present embodiment, the wearer is able to carry out adjustment of the volume as appropriate as he or she is singing while wearing singing assistance mask 1.

In accordance with the present embodiment, using slide member 31 of volume adjustment member 30 to completely close ear proximate notched hole 23 as shown at (a) in FIG. 3 causes the sound conducted through air that is transmitted to the ear of the wearer to be loudest (maximum volume), and completely opening ear proximate notched hole 23 as shown at (b) in FIG. 3 causes the sound conducted through air that is transmitted to the ear of the wearer to be quietest (minimum volume).

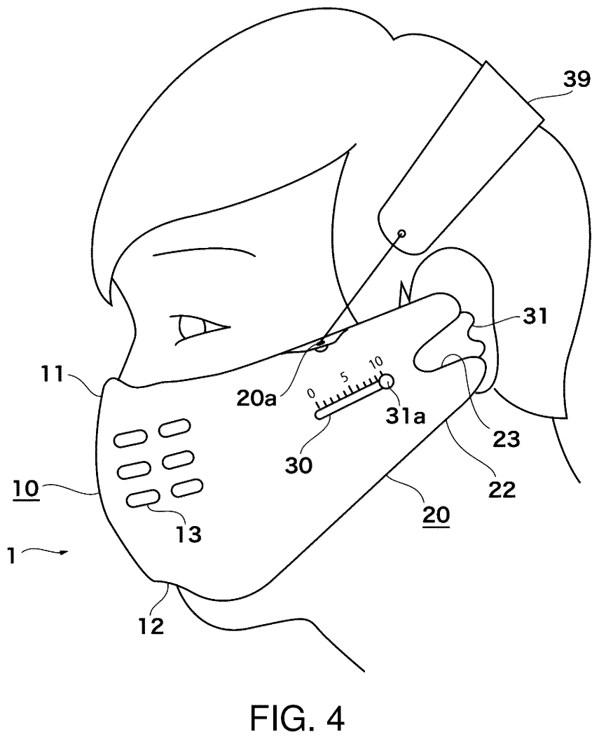

Description of the constitution of singing assistance mask 1 in accordance with the first embodiment having been given above, a manner of using singing assistance mask 1 will now be described. Singing assistance mask 1, which in accordance with the present embodiment might be a mask for a person who is slightly hard of hearing, might, for example, be used by causing it to be worn on the face of a person who is slightly hard of hearing when he or she sings at a karaoke establishment (see FIGS. 3 and 4).

While wearing of singing assistance mask 1 might, for example, be accomplished by causing left and right cheek contacting regions 20 to come in contact with the cheeks from both sides and sandwich the face, for more stable wearing thereof it is preferred as shown in FIG. 4 that it be worn while in addition causing it to be suspended from the back of the head by fastening strap 39.

More specifically, by causing the two ends of fastening strap 39 to be coupled to fastening strap holes 20a formed in the upper portions of left and right cheek contacting regions 20 and wrapping fastening strap 39 around the back of the head, it is possible in accordance with one embodiment to cause singing assistance mask 1 to be suspended from the back of the head.

When singing assistance mask 1 of the present embodiment is worn, the wearer will typically be covered by singing assistance mask 1 over a wide area that extends from the mouth in front to locations in the vicinities of the left and right ears. If while in this state the wearer sings while perhaps holding a microphone in his or her hand or the like, a portion of the sound of the voice emitted from the mouth of the wearer will collides with and be reflected by the inner surface of front mask body 10, and will be guided to the ears of the wearer by way of sound passages 21 at the interior of cheek contacting regions 20.

Accordingly, in accordance with the present embodiment, by singing while wearing singing assistance mask 1, the wearer will be able to directly hear with his or her ears the sound of his or her own voice conducted through air, and will be able to objectively monitor his or her own voice by hearing it in the same way as it would be heard by someone else. That is, the wearer of singing assistance mask 1 in accordance with the present embodiment will be able to correct the way in which he or she sings while listening objectively to his or her own voice.

In accordance with the present embodiment, because the sound of his or her own voice conducted through air may be heard in the same way as his or her own voice would be directly heard by another person present in the same space, the wearer is able to improve his or her singing ability because he or she is able to control the production of his or her own voice while constantly monitoring his or her own voice objectively in real time.

Moreover, in accordance with the present embodiment, because volume adjustment members 30 are provided, the wearer is able, while still wearing singing assistance mask 1, to adjust the volume so as to cause the sound of his or her own voice conducted through air to be heard by the ears with just the right loudness.

In accordance with the present embodiment, when volume is too low, volume may be increased by sliding slide member 31 in a direction such as will cause ear proximate notched hole 23 to be closed, i.e., toward the rear; when volume is too high, volume may be decreased by sliding slide member 31 in a direction such as will cause ear proximate notched hole 23 to be opened, i.e., toward the front.

Furthermore, in accordance with the present embodiment, because a portion of the sound of the voice emitted from the mouth of the wearer is preferably discharged to the exterior from chin concavity 12 of front mask body 10, it is possible even when singing assistance mask 1 is worn for the sound of the voice of the wearer to be picked up directly by a microphone and to be heard by persons nearby who are in the same space in the same way as it would be when it is not worn.

A first embodiment of the present invention has been described above, this embodiment making it possible for a wearer who wears singing assistance mask 1, even when he or she is slightly hard of hearing, to objectively listen to his or her own voice by way of singing assistance mask 1, and, by correcting the way in which he or she sings while monitoring the sound of his or her own voice, to improve his or her singing ability.

In particular, in accordance with the present embodiment, adjustment of the volume of the sound of the voice is not carried out following conversion thereof into an electrical signal, which could cause degradation of sound quality, but adjustment of volume is instead carried out mechanically by causing sliding of slide member 31, which acts on the actual live sound (sound conducted through air), the wearer is able to monitor his or her own actual live voice at an appropriate volume without causing degradation of the sound quality thereof, and is able to appropriately improve his or her singing ability.

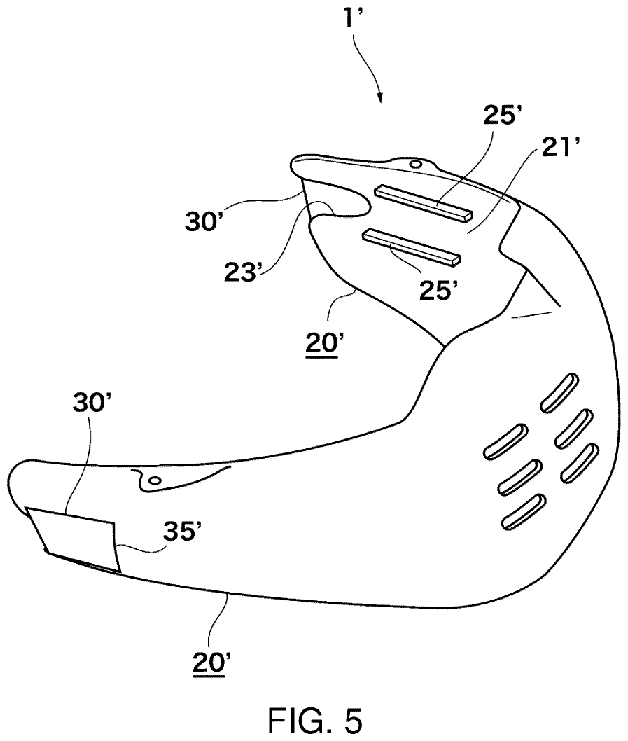

A first variation on the first embodiment will now be described with reference to FIG. 5. Singing assistance mask 1′ associated with the first variation is such that the structure of volume adjustment member 30′ differs from that at the foregoing first embodiment, and also differs from the foregoing first embodiment with respect to the fact that two contact-preventing projecting strips 25′ are formed so as to extend in more or less parallel fashion with respect to the front-to-back/back-to-front direction within sound passage 21′ at the interior of cheek contacting region 20′.

Instead of the slide members 31, slide rails 32, and gradations 33 associated with the first embodiment, singing assistance mask 1′ associated with the first variation comprises, at each the left and right side thereof, removably installed tape 35′ which is removably installable with respect to cheek contacting region 20′ so as to be capable of occluding a prescribed region of ear proximate notched hole 23′ (see FIG. 5).

By varying the area of ear proximate notched hole 23′ that is occluded by removably installed tape 35′, it is possible to adjust the volume of the sound conducted through air that is transmitted to the ear of the wearer in similar fashion as was the case at the foregoing first embodiment.

Furthermore, inasmuch as slide members 31 and slide rails 32 are in accordance with the first variation not provided at the interior of cheek contacting region 20′, there is a possibility that the inside of cheek contacting region 20′ will come in contact with the cheek of the wearer, blocking sound passage 21′. And if sound passage 21′ were to be blocked, it is possible that the sound of the voice of the wearer might no longer be transmitted to his or her ear.

In accordance with the present first variation, it is possible by providing two contact-preventing projecting strips 25′ at the interior of cheek contacting region 20′ to prevent occurrence of a situation in which the inside of cheek contacting region 20′ might otherwise come in contact with the cheek of the wearer and cause sound passage 21′ to become blocked. Note that the form taken by contact-preventing projecting strips 25′, e.g., the locations and shapes thereof, may be varied as appropriate, it being preferred, however, that the form taken thereby be such as will not unduly interfere with the sound that is transmitted from the mouth to the ear along sound passage 21′.

The present first variation may provide operation and effect similar to those at the foregoing first embodiment; and moreover, causing volume adjustment member 30′ to be constituted from removably installed tape 35′ may make it possible to achieve volume adjustment by means of a simple configuration, and may make it possible to greatly reduce the manufacturing cost of singing assistance mask 1′.

### Second Embodiment

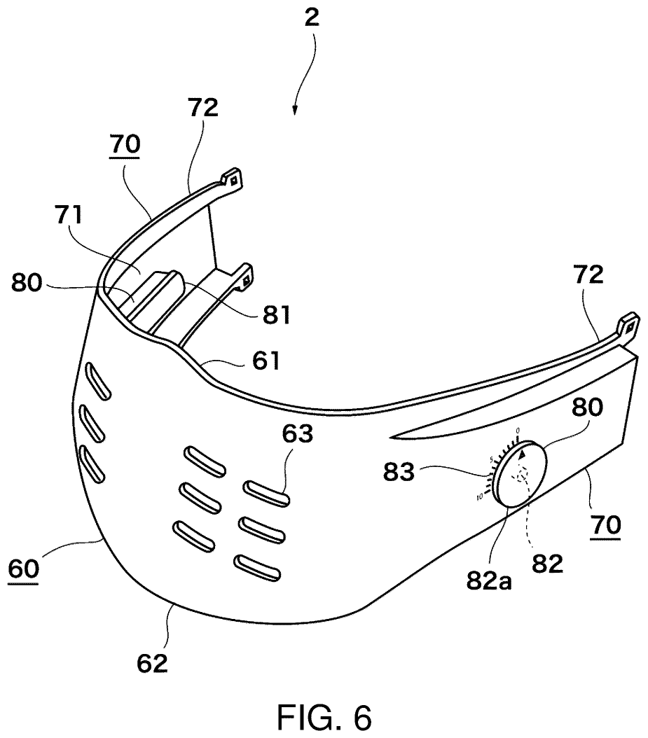

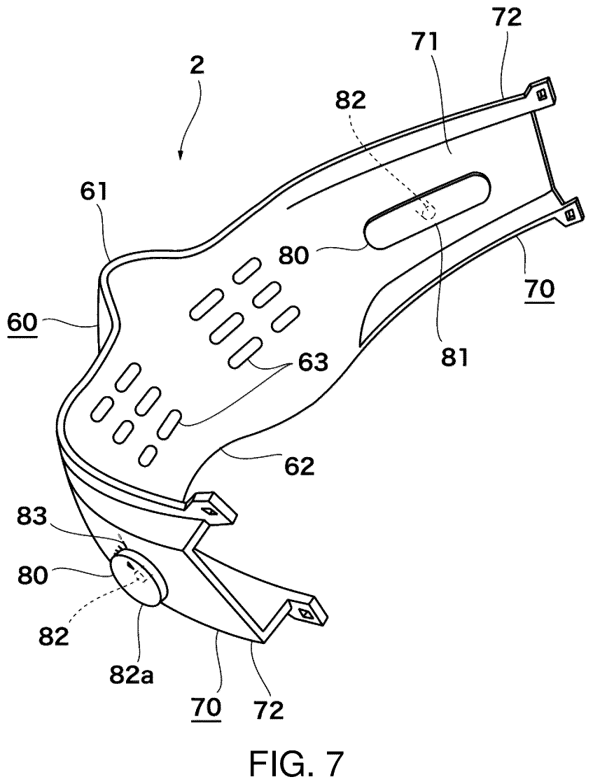

A second embodiment of the present invention will now be described with reference to FIG. 6 through FIG. 12. Singing assistance mask 2 associated with the second embodiment, which might, for example, be a mask for a hearing-unimpaired person, causes the voice which is emitted from the mouth of the wearer to be transmitted to the ears.

Singing assistance mask 2 of the present embodiment might comprise front mask body 60 and cheek contacting regions 70. In accordance with the present embodiment, front mask body 60 and cheek contacting regions 70 may be integrally formed by resin molding. Because much of the constitution of singing assistance mask 2 is common to that of singing assistance mask 1 associated with the foregoing first embodiment, description will primarily be given with respect to where the constitution differs, like members being assigned like names and description thereof being omitted.

Front mask body 60 of the second embodiment, which as in the first embodiment is shaped so as to be convexly curved at the front side thereof, comprises nose convexity 61 which is formed centrally in the lateral direction at an upper portion thereof; chin concavity 62 which is formed centrally in the lateral direction at a lower portion thereof; and a plurality of air holes 63 which are formed at locations displaced to both the left and right sides from the center in the lateral direction.

In accordance with the present embodiment, cheek contacting regions 70, which are plate-like members that extend in continuous and integral fashion from locations toward the front to locations in the vicinities of the cars toward the rear at both the left and right sides of front mask body 60, transmit the sound of the voice of the wearer to the cars as sound conducted through air, and also function so as to cause singing assistance mask 2 to be held to the face as a result of contact made therewith by the cheeks or other such locations at both sides of the head of the wearer.

In accordance with the present embodiment, cheek contacting region 70 may be such that formed therewithin is sound passage 71 which guides sound conducted through air. Length of cheek contacting region 70 is preferably such as will cause ear proximate region 72 which is the back end portion thereof to be just short of reaching the ear when worn by an adult of average size, sound conducted through air which is guided thereto along sound passage 71 preferably being discharged from an opening at the back end of ear proximate region 72 so as to be directed toward the ear.

Cheek contacting region 70 of the present embodiment may further comprise volume adjustment member 80 for adjusting the intensity of the sound that reaches the ear of the wearer as a result of adjustment of the degree to which sound passage 71 is made to be open. Volume adjustment member 80 of the present embodiment might, for example, comprise rotary member 81; rotary shaft 82; and gradations 83.

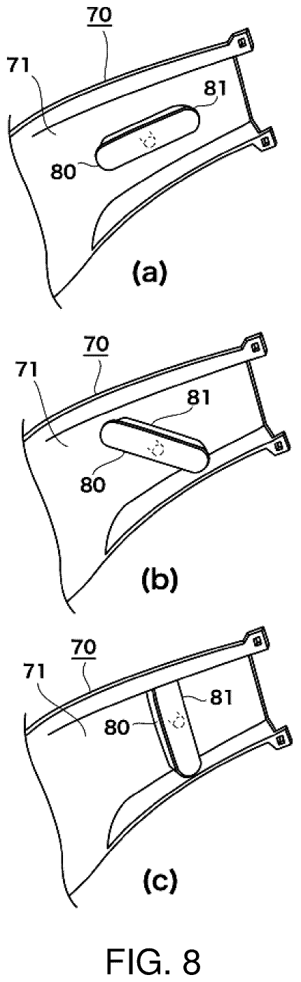

In accordance with the present embodiment, rotary member 81, which may be disposed at a location partway along sound passage 71 at the interior of check contacting region 70, is preferably supported so as to permit rotation about rotary shaft 82, which is perpendicular to the inner surface of cheek contacting region 70. Rotary member 81 is preferably rotatable between a vertical state (closed state; see (c) at FIG. 8) at which it is perpendicular to the front-to-back/back-to-front direction, and a horizontal state (open state; see (a) at FIG. 8) at which it is parallel to the front-to-back/back-to-front direction.

Rotary member 81 is preferably shaped so as to conform to the shape of the inner surface of check contacting region 70 at which it is installed, and is preferably formed in such shape as to not produce a large gap between the inner surface of cheek contacting region 70 and rotary member 81 when rotary member 81 is in its perpendicular state.

In accordance with the present embodiment, when rotary member 81 is in its perpendicular state, sound passage 71 is closed off by rotary member 81, creating a closed state in which sound conducted through air is almost completely incapable of passing therethrough along the interior of sound passage 71. In accordance with the present embodiment, when rotary member 81 is in its horizontal state, sound passage 71 is made to be open, creating an open state in which sound conducted through air is able to freely pass therethrough along the interior of sound passage 71.

That is, in accordance with the present embodiment, when rotary member 81 is in its vertical closed state, the intensity of the sound conducted through air that passes through sound passage 71 is a minimum, and the intensity of the sound that is transmitted to the ear of the wearer is also a minimum (minimum volume). Conversely, when rotary member 81 is in its horizontal open state, the intensity of the sound conducted through air that passes through sound passage 71 is a maximum, and the intensity of the sound that is transmitted to the ear of the wearer is also a maximum (maximum volume).

Rotary shaft 82 of the present embodiment preferably comprises disc-shaped knob 82a which might be integrally connected in coaxial fashion therewith and which might be exposed at the exterior of cheek contacting region 70, such that it is possible by rotating this knob 82a to cause rotation of rotary shaft 82 and to cause rotation of rotary member 81.

Gradations 83, which are preferably inscribed peripherally about knob 82a of rotary shaft 82 at the outside of check contacting region 70, may indicate the degree to which sound passage 71 has been made to be open as a result of adjustment by rotary member 81; i.e., the volume of the sound of the voice that reaches the ear of the wearer from sound passage 71.

Description of the constitution of singing assistance mask 2 has been given above; singing assistance mask 2 may be used in a manner similar to that at singing assistance mask 1 associated with the foregoing first embodiment, operation and effect thereof being similar thereto. Because ear proximate region 72 of singing assistance mask 2 will typically not cover the ear of the wearer as is typically the case in the first embodiment, sound conducted through air that has been discharged from an opening at the back end of ear proximate region 72 which is located in the vicinity of the front side of the ear being transmitted to the ear of the wearer, the volume of the sound of the voice that is transmitted to the ear will typically be lower than was the case in the first embodiment.

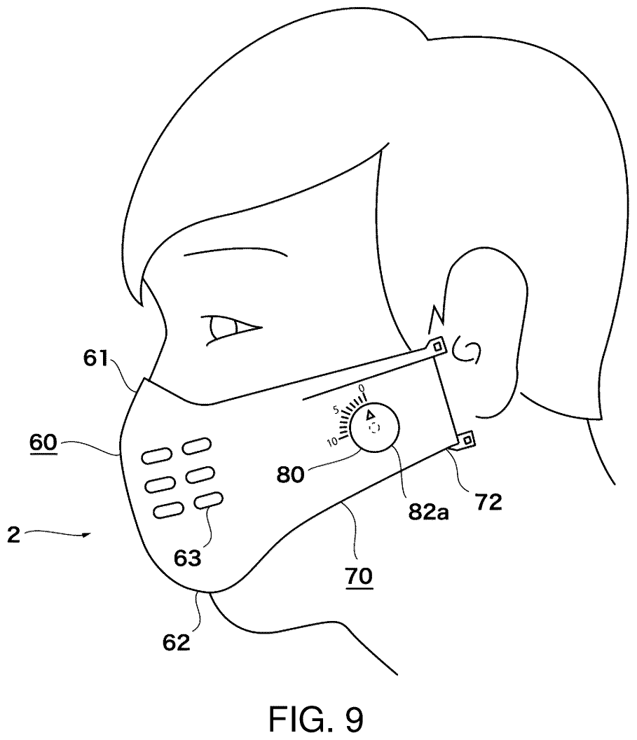

Accordingly, singing assistance mask 2, which might, for example, be a mask for a hearing-unimpaired person, i.e., someone whose ears can hear comparatively well, might, for example, be used by causing it to be worn on the face of a hearing-unimpaired person when he or she sings at a karaoke establishment (see FIG. 9).

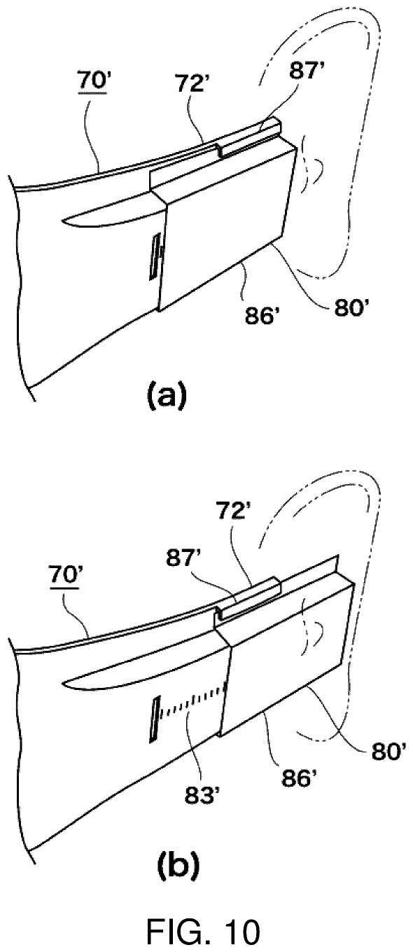

A second variation on the second embodiment will now be described with reference to FIG. 10. A singing assistance mask associated with the present second variation is such that the structure of volume adjustment member 80′ differs from that at the foregoing second embodiment. Volume adjustment member 80′ associated with the present second variation is such that by causing ear proximate region 72′ which is at the back end of cheek contacting region 70′ to be extended toward the rear, it is possible to adjust the volume of the sound that is transmitted to the ear of the wearer.

Volume adjustment member 80′ of the second variation may comprise extensible slide member 86′ which may be slidable in the front-to-back/back-to-front direction relative to cheek contacting region 70′ and may comprise slide rail 87′ for slidably retaining extensible slide member 86′, volume gradations 83′ preferably being formed at the outside surface of ear proximate region 72′.

Extensible slide member 86′ of the second variation is preferably of C-shaped cross-section, being convex toward the exterior, as viewed in a horizontal plane perpendicular to the front-to-back/back-to-front direction, and preferably has a structure that is slightly larger than that of the main body of ear proximate region 72′ of cheek contacting region 70′. The concavity at the inside of extensible slide member 86′ may function as a sound passage. Extensible slide member 86′ is preferably slidable between a frontmost position at which it is most toward the front as shown at (a) in FIG. 10, and a backmost position at which it is most toward the back as shown at (b) in FIG. 10, sliding of extensible slide member 86′ preferably causing length of the sound passage (ear proximate region 72′) to increase and decrease.

In accordance with the second variation, when extensible slide member 86′ is in its frontmost position, it will preferably be in a state such that the back end of ear proximate region 72′ does not reach the ear, and the length of the sound passage will preferably be in its shortest state. In accordance with the second variation, when extensible slide member 86′ is in its backmost position, the back end of ear proximate region 72′ will preferably be extended so as to be at a location at which it covers the ear, the inside of extensible slide member 86′ will preferably constitute the back end portion of the sound passage, and the length of the sound passage will preferably be in its longest state.

In accordance with the second variation, when the sound passage is in its shortest state ((a) in FIG. 10), the volume of the sound that is transmitted to the ear of the wearer is a minimum (minimum volume); when the sound passage is in its longest state ((b) in FIG. 10), the volume of the sound that is transmitted to the ear of the wearer is a maximum (maximum volume).

The present second variation may provide operation and effect similar to those at the foregoing second embodiment; and moreover, because it can preferably be extended and retracted so as to be at a position at which the ear is covered by ear proximate region 72′ or a position at which it is not covered thereby, and because it preferably allows volume to be adjusted greatly over a wide range, it may make it possible to provide a singing assistance mask that is capable of accommodating a wide variety of circumstances, from those involving persons having normal hearing to those involving persons who are hard of hearing.

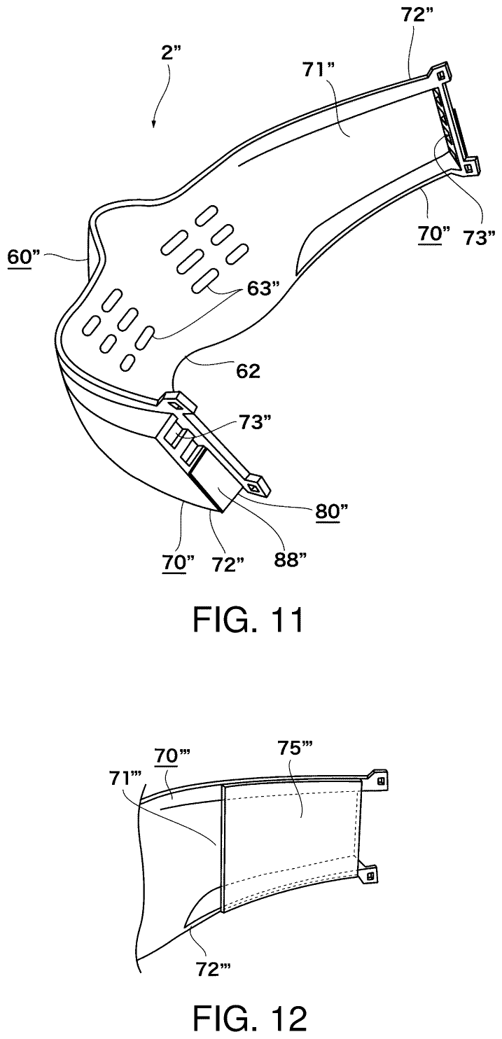

A third variation on the second embodiment will now be described with reference to FIG. 11. Singing assistance mask 2″ associated with the present third variation is such that the structure of volume adjustment member 80″ differs from that at the foregoing second embodiment.

Instead of the rotary members 81, rotary shafts 82, and gradations 83 associated with the second embodiment, volume adjustment member 80″ associated with the third variation is such that lattice holes 73″ which are lattice-like holes are formed at the back end opening portion of ear proximate region 72″ which constitutes sound passage 71″; and moreover, is such that it comprises, at each the left and right side thereof, removably installed tape 88″ which is removably installable with respect to cheek contacting region 70″ so as to be capable of occluding a prescribed region of lattice holes 73″.

In accordance with the third variation, by varying the area of lattice holes 73″ that are occluded by removably installed tape 88″, it is possible to adjust the volume of the sound conducted through air that is transmitted to the ear of the wearer in similar fashion as was the case at the foregoing second embodiment. The present third variation may provide operation and effect similar to those at the foregoing second embodiment, and may also make it possible to greatly reduce the manufacturing cost of singing assistance mask 2″.

A fourth variation on the second embodiment will now be described with reference to FIG. 12. A singing assistance mask associated with the present fourth variation is such that the structure of ear proximate region 72′″ at cheek contacting region 70″ differs from that at the foregoing second embodiment.

In accordance with the fourth variation, ear proximate region 72″ is such that further provided thereat is sound passage cover 75″ which covers the inside of sound passage 71″, causing a tunnel-like structure to be formed at sound passage 71″. The present fourth variation may provide operation and effect similar to those at the foregoing second embodiment; and moreover, because it ensures stable formation of sound passage 71″, it may make it possible, regardless of the shape of the face of the wearer and so forth, to prevent occurrence of a situation in which sound passage 71″ might otherwise become blocked as a result of coming in contact with the cheek, and may make it possible for the sound of the voice to be stably transmitted from the mouth to the ear.

While embodiments of the present invention including variations thereon have been described above, modes of carrying out the present invention are not limited to the foregoing embodiments, a great many variations being possible without departing from the gist of the present invention. For example, the shapes, sizes, materials, and so forth of the parts from which the singing assistance mask is constituted may be varied as appropriate.

### EXPLANATION OF REFERENCE NUMERALS

1 Singing assistance mask
10 Front mask body
11 Nose convexity
12 Chin concavity
13 Air hole
20 Cheek contacting region
20a Fastening strap hole
21 Sound passage
22 Ear covering region (ear proximate region)
23 Ear proximate notched hole
25′ Contact-preventing projecting strip
30 Volume adjustment member
31 Slide member
31a Knob
32 Slide rail
33 Gradations
39 Fastening strap
2 Singing assistance mask
60 Front mask body
61 Nose convexity
62 Chin concavity
63 Air hole
70 Check contacting region
71 Sound passage
72 Ear proximate region
80 Volume adjustment member
81 Rotary member
82 Rotary shaft
82a Knob
83 Gradations

What is claimed is:

1. A singing assistance mask that transmits a voice emitted from a mouth of a wearer to ears as sound conducted through air, the singing assistance mask comprising:
a front mask body that covers the mouth; and
cheek contacting regions that extend in a front-to-back/back-to-front direction so as to be directed toward locations in vicinities of the ears at left and right sides of the front mask body, and that have formed at insides thereof concavities constituting sound passages which guide the voice as the sound conducted through air to the ears of the wearer;
wherein the cheek contacting regions comprise volume adjustment members for mechanically adjusting volume of the sound conducted through air that is transmitted to the ears.

2. The singing assistance mask according to claim 1 wherein
ear proximate notched holes are formed at back ends of the cheek contacting regions; and
the volume adjustment members adjust degrees to which the ear proximate notched holes are made to be open.

3. The singing assistance mask according to claim 2 wherein the volume adjustment members comprise slide members that are capable of slidably occluding the ear proximate notched holes, the volume being adjusted by causing areas of the ear proximate notched holes that are occluded by the slide members to be varied.

4. The singing assistance mask according to claim 2 wherein the volume adjustment members comprise removably installed tape which is removably installable with respect to the cheek contacting regions so as to be capable of occluding prescribed regions of the ear proximate notched holes, the volume being adjusted by causing areas of the ear proximate notched holes that are occluded by the removably installed tape to be varied.

5. The singing assistance mask according to claim 1 wherein the volume adjustment members comprise rotary members which are disposed within the sound passages so as to permit rotation about rotary shafts which are perpendicular to inner surfaces of the cheek contacting regions, the volume being adjusted by causing degrees to which the sound passages are made to be open to be adjusted by the rotary members.

6. The singing assistance mask according to claim 1 wherein the volume adjustment members comprise extensible slide members that are slidable in the front-to-back/back-to-front direction relative to the cheek contacting regions and are capable of causing ear proximate regions at back ends of the cheek contacting regions to be extended toward the rear, and that have formed at the insides thereof the concavities that function as the sound passages, the volume being adjusted by causing the ear proximate regions to be extended or retracted.

7. The singing assistance mask according to claim 1 wherein the front mask body is such that air holes for breathing by the wearer are formed at locations displaced to both the left and the right sides from a midpoint in a lateral direction.

8. The singing assistance mask according to claim 2 wherein the front mask body is such that air holes for breathing by the wearer are formed at locations displaced to both the left and the right sides from a midpoint in a lateral direction.

9. The singing assistance mask according to claim 3 wherein the front mask body is such that air holes for breathing by the wearer are formed at locations displaced to both the left and the right sides from a midpoint in a lateral direction.

10. The singing assistance mask according to claim 4 wherein the front mask body is such that air holes for breathing by the wearer are formed at locations displaced to both the left and the right sides from a midpoint in a lateral direction.

11. The singing assistance mask according to claim 5 wherein the front mask body is such that air holes for breathing by the wearer are formed at locations displaced to both the left and the right sides from a midpoint in a lateral direction.

12. The singing assistance mask according to claim 6 wherein the front mask body is such that air holes for breathing by the wearer are formed at locations displaced to both the left and the right sides from a midpoint in a lateral direction.
